(19) United States
(12) Patent Application Publication
(10) Pub. No.: US 2024/0055698 A1
(43) Pub. Date: Feb. 15, 2024

(54) CHARGE-DISCHARGE DEVICE WITH ACTIVE TEMPERATURE CONTROL

(71) Applicant: Lee-Fei Chen, Taipei City (TW)

(72) Inventor: Lee-Fei Chen, Taipei City (TW)

(21) Appl. No.: 17/886,057

(22) Filed: Aug. 11, 2022

(51) Int. Cl. H01M 10/6572; H01M 10/6551; H01M 10/6563

(52) U.S. Cl. CPC H01M 10/6572; H01M 10/6551; H01M 10/6563

(57) ABSTRACT

A charging and discharging device with active temperature control includes an outer shell, an inner shell, a battery module, a controller and at least one temperature sensor. Wherein, the inner shell includes a thermoelectric material layer. The controller can determine whether the temperature inside the inner shell is within a working temperature range of the battery module according to the at least one temperature sensor. When the temperature inside the inner shell is not within the working temperature range of the battery module, the controller actively controls the battery module to output a supply voltage to the thermoelectric material layer. Then the temperature inside the inner shell can be controlled to rise or fall according to the principle of the thermoelectric effect, thereby changing and maintaining the battery module's temperature within the working temperature range to operate normally.

### BACKGROUND OF THE INVENTION

### 1. Field of the Invention

The present invention relates to a charge-discharge device, in particular to a charge-discharge device with active temperature control.

### 2. Description of the Prior Arts

Environmental protection and energy saving are one of the main trends of technological development in recent years. Therefore, batteries that can be repeatedly charged and discharged are widely used in charge-discharge devices in various life and industrial fields, such as charge-discharge devices for electric motorcycles and electric vehicles. This type of charge-discharge device includes a battery pack composed of at least one rechargeable battery. In order to meet the usage habits of general consumers and improve the convenience of use of products, charging efficiency and safety of rechargeable batteries are key features that must be taken into account and improved for such rechargeable products at the same time. No matter what material the rechargeable battery is made of, it has a suitable working temperature range for normal operation. When the battery temperature is higher or lower than the working temperature range, the efficiency of the charging and discharging of the rechargeable battery would be degraded.

However, the rechargeable battery generates a large amount of heat energy during charging/discharging, which increases the temperature of the battery. If the heat energy is not dissipated in time, the temperature of the rechargeable battery during charging/discharging may continue to rise beyond the working temperature range. However, overheating may make the rechargeable battery work improperly, even leading to battery damage and more serious danger such as explosion and injury. On the other hand, when the temperature of the charge-discharge device is far below its working temperature range, the electrolyte in the rechargeable battery may condense and the stored electrical energy capacity may be greatly reduced, which result in poor charging/discharging efficiency of the rechargeable battery.

In conclusion, due to the limitation of ambient temperature, in order to charge/discharge the rechargeable battery of the charging and discharging device with high efficiency and at the same time ensure its safety in use, the existing charge-discharge device including the rechargeable battery must be further improved.

### SUMMARY OF THE INVENTION

In view of the drawbacks that the battery temperature of the rechargeable battery is higher or lower than its working temperature range and that it is not efficient to the charge-discharge work and may even be dangerous, the present invention provides a charge-discharge device with active temperature control, comprising:
an outer shell having a first accommodating space, at least one air inlet and at least one air outlet, wherein the at least one air inlet and the at least one air outlet communicate with the first accommodating space;
an inner shell disposed in the first accommodating space and having a second accommodating space, an inner peripheral surface and an outer peripheral surface, wherein the inner shell includes a thermoelectric material layer;
two power input terminals electrically connected to the thermoelectric material layer, wherein when the two power input terminals receive a supply voltage, a temperature difference is generated between the inner peripheral surface and the outer peripheral surface;
a battery module disposed in the second accommodating space of the inner shell for connecting an external charging power source to receive a charging voltage or connecting a load to transmit a discharging voltage;
at least one temperature sensor disposed in the second accommodating space of the inner shell, for sensing the temperature of the second accommodating space and generating at least one temperature sensing information; and
a controller correspondingly electrically connected to the at least one temperature sensor for receiving the at least one temperature sensing information output from the at least one temperature sensor, and controlling the battery module to output supply voltage to the thermoelectric material layer according to the at least one temperature sensing information.

The controller can determine whether the temperature of the second accommodating space is within a working temperature range of the battery module according to the at least one temperature sensor. When the temperature of the second accommodating space is not within the working temperature range, the controller actively controls the battery module to output the power supply voltage to the thermoelectric material layer. According to the principle of thermoelectric effect, the inner shell achieves the effect of heating or cooling to change the temperature of the second accommodating space, thereby maintaining the temperature of the battery module within the working temperature range to operate normally.

### BRIEF DESCRIPTION OF THE DRAWINGS

FIG. 1 is a three-dimensional partial cross-sectional schematic diagram of the charge-discharge device with active temperature control.

FIG. 2 is a three-dimensional perspective schematic diagram of the inner shell of an embodiment of the present invention.

FIG. 3 is a schematic top cross-sectional view of the inner shell of an embodiment of the present invention.

FIG. 4 is a schematic perspective view of the separation of the power module according to an embodiment of the present invention.

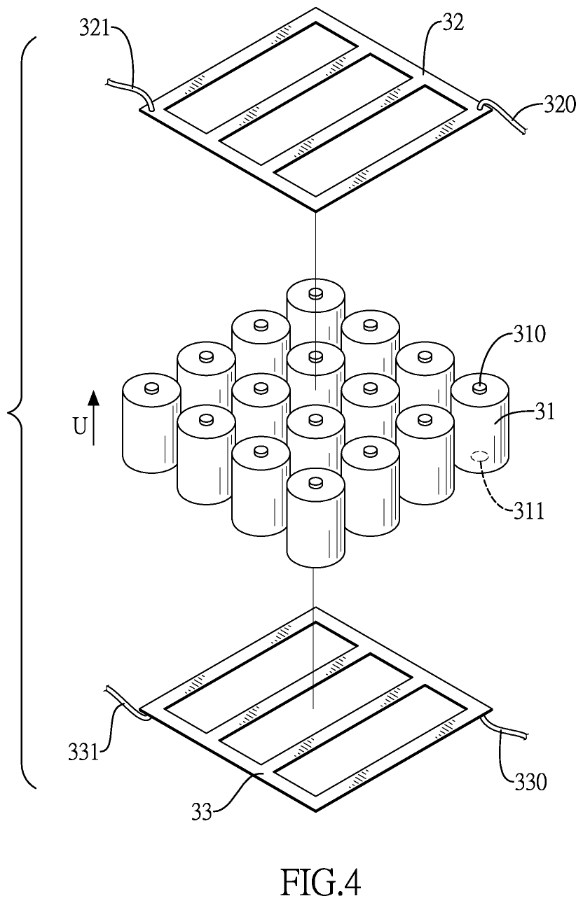

FIG. 5 is a schematic top cross-sectional view of the charge-discharge device with active temperature control.

FIG. 6 is a partial schematic side view of an embodiment of the present invention.

FIG. 7 is a three-dimensional schematic diagram of the inner shell of an embodiment of the present invention.

### DETAILED DESCRIPTION OF THE PREFERRED EMBODIMENTS

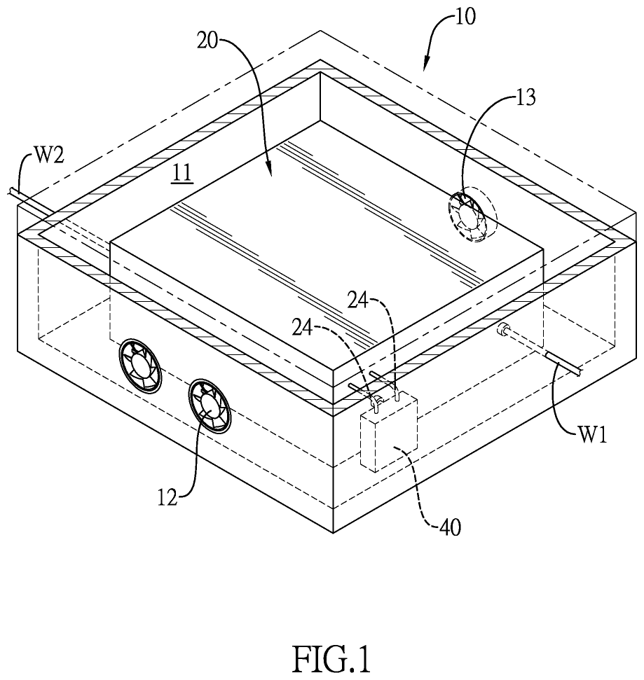

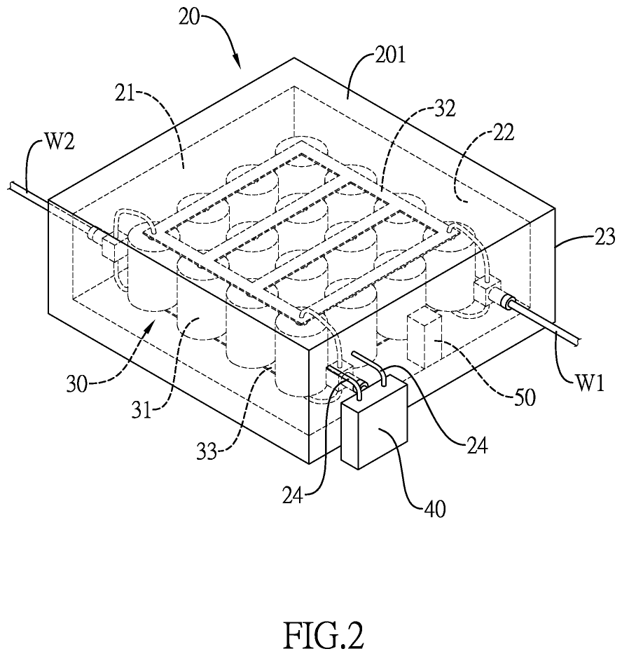

Referring to FIG. 1 and FIG. 2, the present invention is a charge-discharge device with active temperature control, which includes an outer shell 10, an inner shell 20, a battery module 30, a controller 40 and at least one temperature sensor 50.

The outer shell 10 is formed with a first accommodating space 11, and has at least one air inlet and at least one air outlet. The at least one air inlet and the at least one air outlet communicate with the first accommodating space 11. In a preferred embodiment of the present invention, the at least one air inlet and the at least one air outlet are respectively disposed on opposite sides of the outer shell 10, so that the air flowing into the first accommodating space 11 has a better convection effect. In addition, in a preferred embodiment of the present invention, the outer shell 10 further includes at least one extractor fan 12 and at least one exhaust fan 13. The at least one extractor fan 12 and the at least one exhaust fan 13 are respectively disposed in the at least one air inlet and the at least one air outlet to increase the efficiency of air flow in the first accommodating space 11.

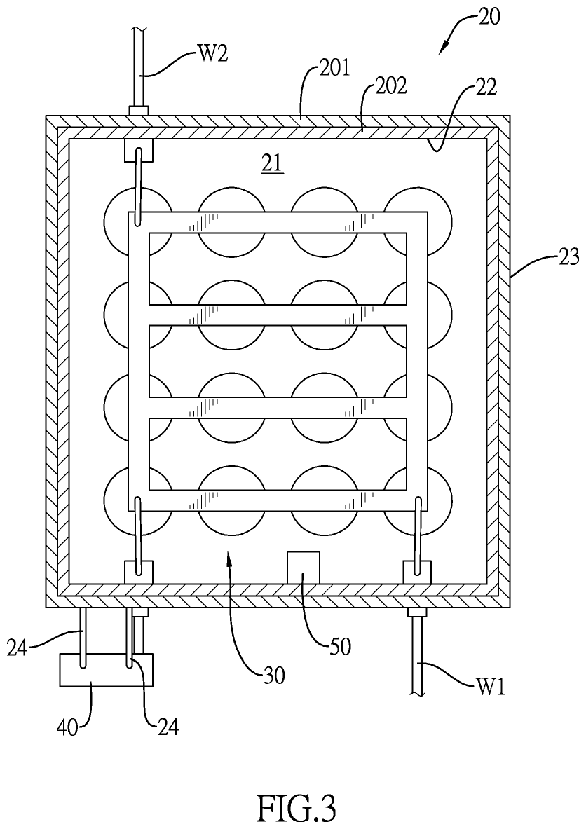

The inner shell 20 is disposed in the first accommodating space 11. As shown in FIG. 2, the inner shell 20 is formed with a second accommodating space 21 and has an inner peripheral surface 22 and an outer peripheral surface 23. The inner peripheral surface 22 is all the inner surface of the inner shell 20. The outer peripheral surface 23 is all the outer surface of the inner shell 20. In addition, the inner shell 20 includes a thermoelectric material layer 201, and two power input terminals 24 are connected to the thermoelectric material layer 201. In a preferred embodiment of the present invention, the inner shell 20 is entirely made of the thermoelectric material layer 201. In another preferred embodiment of the present invention, as shown in FIG. 3, the inner shell 20 includes a heat conduction shell 202. The thermoelectric material layer 201 is disposed on the outer surface of the heat conduction shell 202.

When the two power input terminals 24 receive a supply voltage, the thermoelectric material layer causes a temperature difference between the inner peripheral surface 22 and the outer peripheral surface 23 of the inner shell 20 according to the principle of thermoelectric effect. When the polarities of the power supply voltages applied to the two power input terminals 24 are opposite, the temperature difference between the inner peripheral surface 22 and the outer peripheral surface 23 are also opposite. Specifically, when the power supply voltages with different polarities are supplied to the thermoelectric material layer 201, the temperature of the inner peripheral surface 22 of the inner shell 20 can be lower or higher than the temperature of the outer peripheral surface 23.

In a preferred embodiment of the present invention, the supply voltage is a first voltage or a second voltage. Wherein, the first voltage and the second voltage have opposite polarities. When the supply voltage is the first voltage, the temperature of the inner peripheral surface 22 of the inner shell 20 is lower than the temperature of the outer peripheral surface 23. When the supply voltage is the second voltage, the temperature of the inner peripheral surface 22 of the inner shell 20 exceeds the temperature of the outer peripheral surface 23.

In a preferred embodiment of the present invention, the battery module 30 is disposed in the inner shell 30 of the second accommodating space 31. The battery module 30 is connected to an external charging power supply (not shown) through a charging wire W1 to receive a charging voltage, or is connected to a load through a discharging wire W2 (not shown) to transmit a discharge voltage. In a preferred embodiment of the present invention, the battery module 30 includes at least one battery 31. The battery 31 has an anode and a cathode 311. When the anode 310 and the cathode 311 are respectively connected to the anode and cathode of the external charging power supply. The battery 31 can receive the charging voltage for charging. When the anode 310 and the cathode 311 are respectively connected to the anode and cathode of the load, the battery 31 can discharge the load.

In a preferred embodiment of the present invention, the battery module 30 further includes a positive conductive sheet 32 and a negative conductive sheet 33. The anode 310 of the battery 31 faces a first direction U. The positive conductive sheet 32 is electrically connected to the anode 310 of each battery 31, and the negative conductive sheet 33 is electrically connected to the cathode 311 of each battery 31. The positive conductive sheet 32 and the negative conductive sheet 33 are electrically connected to the external charging power supply to charge the batteries 31, or the positive conductive sheet 32 and the negative conductive sheet 33 are electrically connected to the load to discharge the batteries 31. In this preferred embodiment, the positive conductive sheet 32 is further connected to a first charging wire 320 and a first discharging wire 321. The negative conductive sheet 33 is further connected to a second charging wire 330 and a second discharging wire 331. The first charging wire 320 and the second charging wire 330 are connected to the external charging power supply for charging, and the first discharging wire 321 and the second discharging wire 331 are connected to the load for discharging.

Both the controller 40 and the at least one temperature sensor 50 are powered by the battery module 30. The controller 40 is used to control the battery module 30 to output the power supply voltage to the thermoelectric material layer 201 and control the polarity of the power supply voltage, so that the temperature of the inner peripheral surface 22 of the inner shell 20 is lower than or higher than that of the outer peripheral surface. In addition, the extractor fan 12 and the exhaust fan 13 of the outer shell 10 are respectively electrically connected to the controller 40 and controlled by the controller 40 to be turned on or off. The at least one temperature sensor 50 is disposed in the second accommodating space 21 of the inner shell 20 for sensing the temperature of the second accommodating space 21 and generating at least one temperature sensing information. The at least one temperature sensor 50 is correspondingly electrically connected to the controller 40 and transmits the at least one temperature sensing information to the controller 40.

The battery module 30 has a working temperature range. In the present invention, the controller 40 controls the temperature of the battery module 30 within the working temperature range. Specifically, the controller 40 can be preset with an upper limit and a lower limit. When the temperature of the battery module 30 exceeds the upper limit, the battery module 30 needs to be dissipated. When the temperature of the battery module 30 is lower than the lower limit, the battery module 30 needs to be heated. When the temperature of the battery module 30 is between the upper limit and the lower limit, the battery module 30 can work in an ideal state.

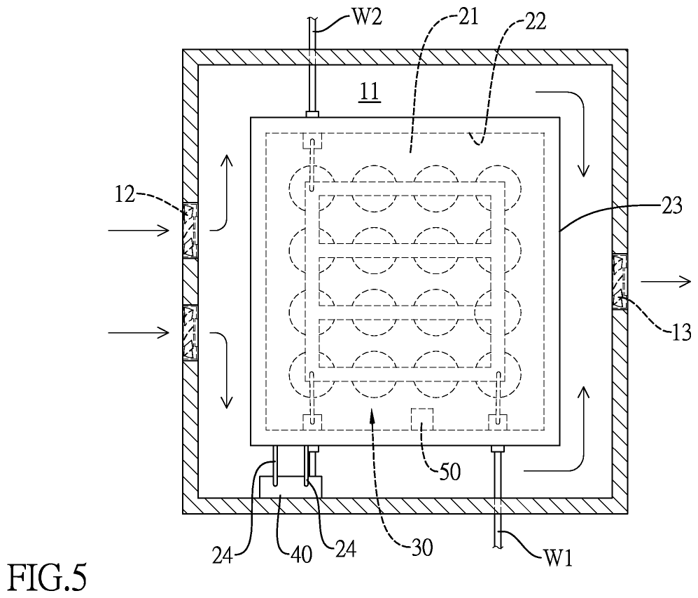

Referring to FIG. 5, when the battery module 30 is being charged or discharged, the temperature of the second accommodating space 21 can be gradually increased due to the large amount of thermal energy generated by the battery 31. When the controller 40 determines that the temperature of the second accommodating space 21 exceeds the upper limit (such as 45° C.) according to the temperature sensing information, the controller 40 controls the power supply voltage to be the first voltage. So that the temperature of the inner peripheral surface 22 of the inner shell 20 is lower than the temperature of the outer peripheral surface 23. By maintaining the temperature difference, the temperature of the second accommodating space 21 is lower than the temperature of the first accommodating space 11, thereby reducing the temperature of the battery module 30. In addition, the controller 40 controls the extractor fan 12 and the exhaust fan 13 to turn on. The heat of the inner shell 20 can be dissipated out of the first accommodating space 11 by the flowing air, thereby increasing the efficiency of temperature reduction. In summary, the battery module 30 can improve the charging (discharging) efficiency and at the same time avoids the risk of overheating or explosion caused by the high temperature of the battery 31 during the charging (discharging) process.

When the present invention is placed in a cold area, the controller 40 determines that the temperature of the second accommodating space 21 is lower than the lower limit, such as 45° C., according to the temperature sensing information of the at least one temperature sensor 50 C, the controller 30 controls the supply voltage to be the second voltage. Then the temperature of the inner peripheral surface 22 of the inner shell 20 exceeds the temperature of the outer peripheral surface 23. And the temperature of the second accommodating space 21 exceeds the temperature of the first accommodating space 11 by maintaining the temperature difference, thereby increasing the temperature of the battery module 30 and preventing the battery 31 from reducing the energy capacity that can be stored due to the low temperature, resulting in poor charging (discharging) efficiency.

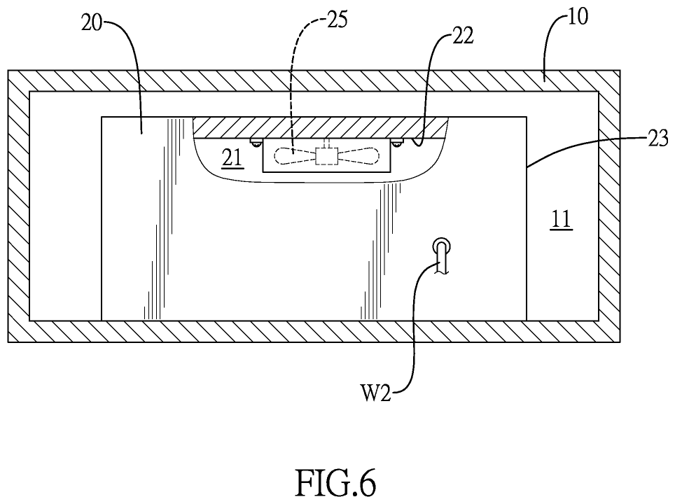

Referring to FIG. 6, in a preferred embodiment of the present invention, the inner shell 20 may further include at least one circulation fan 25. The circulation fan 25 is disposed in the second accommodating space 21 for increasing the air flow efficiency in the second accommodating space 21. The circulating fan 25 is correspondingly electrically connected to the controller 40 and is turned on or off by the controller 40. When the controller 40 controls the battery module 30 to output the power supply voltage, it simultaneously turns on the circulation fan 14. In this way, the temperature in the second accommodating space 21 can be uniformly distributed, so as to avoid the occurrence of local high temperature or low temperature in the battery module 30.

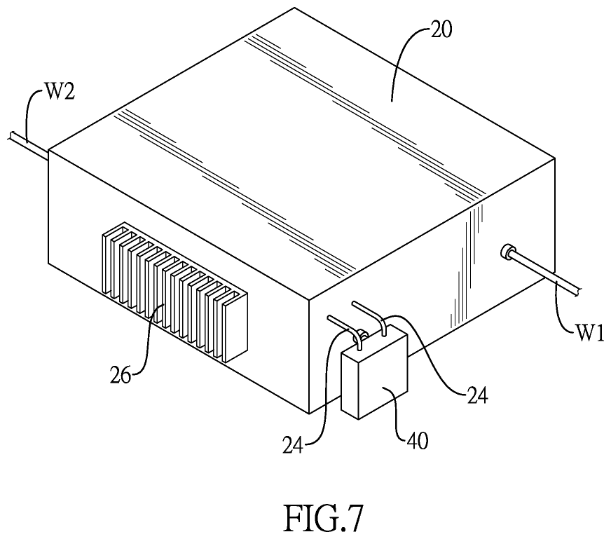

Referring to FIG. 7, in a preferred embodiment of the present invention, the inner shell 20 may further include a cooling fin 26. The cooling fin 26 is disposed on the outer peripheral surface 23 for increasing the heat dissipation efficiency of the outer peripheral surface 23. Preferably, the cooling fin 26 can be disposed around the entire periphery of the outer peripheral surface 23.

The controller 40 can determine whether the temperature of the second accommodating space 21 is within a working temperature range of the battery module 30 according to the at least one temperature sensor 50. When the temperature of the second accommodating space 21 is not within the working temperature range, the controller 40 actively controls the battery module 30 to output the power supply voltage to the thermoelectric material layer 201. According to the principle of thermoelectric effect, the inner shell 20 warms up or cools down to change the temperature of the second accommodating space 21, thereby maintaining the temperature of the battery module within the working temperature range to operate normally.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A charge-discharge device with active temperature control comprising:
an outer shell having a first accommodating space, at least one air inlet and at least one air outlet, wherein the at least one air inlet and the at least one air outlet communicate with the first accommodating space;
an inner shell disposed in the first accommodating space and having a second accommodating space, an inner peripheral surface and an outer peripheral surface, wherein the inner shell includes a thermoelectric material layer;
two power input terminals electrically connected to the thermoelectric material layer, wherein when the two power input terminals receive a supply voltage, a temperature difference is generated between the inner peripheral surface and the outer peripheral surface;
a battery module disposed in the second accommodating space of the inner shell for connecting an external charging power source to receive a charging voltage or connecting a load to transmit a discharging voltage;
at least one temperature sensor disposed in the second accommodating space of the inner shell, for sensing the temperature of the second accommodating space and generating at least one temperature sensing information; and
a controller correspondingly electrically connected to the at least one temperature sensor for receiving the at least one temperature sensing information output from the at least one temperature sensor, and controlling the battery module to output supply voltage to the thermoelectric material layer according to the at least one temperature sensing information.

2. The charge-discharge device with active temperature control as claimed in claim 1, wherein, the inner shell is entirely made of the thermoelectric material layer.

3. The charge-discharge device with active temperature control as claimed in claim 1, wherein the inner shell includes a heat-conducting shell, and the thermoelectric material layer is disposed on the outer surface of the heat-conducting shell.

4. The charge-discharge device with active temperature control as claimed in claim 1, wherein,
when the supply voltage is a first voltage, the temperature of the inner peripheral surface of the inner shell is lower than the temperature of the outer peripheral surface;
when the supply voltage is a second voltage, the temperature of the inner peripheral surface of the inner shell exceeds the temperature of the outer peripheral surface;
wherein the polarity of the second voltage is opposite to that of the first voltage.

5. The charge-discharge device with active temperature control as claimed in claim 4, wherein, the controller is preset with an upper limit and a lower limit and determines the temperature of the second accommodating space according to the temperature sensing information of the at least one temperature sensor;
when the temperature of the second accommodating space exceeds the upper limit, the controller controls the power supply voltage to be the first voltage;
when the temperature of the second accommodating space is lower than the lower limit, the controller controls the power supply voltage to be the second voltage.

6. The charge-discharge device with active temperature control as claimed in claim 1, wherein, the battery module further includes:
at least one battery, wherein each battery has an anode and a cathode, and the anode of the battery faces a first direction;
a positive conductive sheet electrically connected to the anode of each battery and connected with a first charging wire and a first discharging wire; and
a negative conductive sheet electrically connected to the cathode of each battery and connected with a second charging wire and a second discharging wire;
wherein, the first charging wire and the second charging wire are for connecting to the external charging power supply, and the first discharge wire and the second discharge wire are for connecting to the load.

7. The charge-discharge device with active temperature control as claimed in claim 1, wherein, the outer shell further includes:
at least one extractor fan, respectively disposed at the at least one air inlet; and
at least one exhaust fan, respectively disposed at the at least one air outlet;
wherein, the controller is connected to the extractor fan and the exhaust fan and controls them to be turned on or off.

8. The charge-discharge device with active temperature control as claimed in claim 1, wherein, the at least one air inlet and the at least one air outlet are respectively disposed on opposite sides of the outer shell.

9. The charge-discharge device with active temperature control as claimed in claim 1, wherein, the inner shell further includes:
at least one circulation fan, wherein each circulation fan is disposed in the second accommodating space, is electrically connected with the controller and is controlled by the controller to be turned on or off.

10. The charge-discharge device with active temperature control as claimed in claim 1, wherein, the inner shell further includes:
a cooling fin disposed on the outer peripheral surface of the inner shell.
